(19) United States
(12) Patent Application Publication
(10) Pub. No.: US 2009/0005977 A1
(43) Pub. Date: Jan. 1, 2009

(54) VEHICLE NAVIGATION SYSTEMS AND METHODS

(75) Inventors: WEN-HUNG CHUNG, Tu-Cheng (TW); YING-HAO HSU, Tu-Cheng (TW); FU-CHI YANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/147,491

(22) Filed: Jun. 27, 2008

(30) Foreign Application Priority Data
Jun. 29, 2007 (CN) 200710200972.5

(51) Int. Cl. G01C 21/34; G01C 21/00; G01S 5/00

(52) U.S. Cl. 701/209; 701/208

(57) ABSTRACT

A vehicle navigation system includes a GPS signal processor, an image processing module, a memory, a microprocessor, a navigation adjusting module, and a display module. The GPS signal processor receives GPS signals and obtains an unadjusted navigation position according to the GPS signals. The image processing module captures pictures of surrounding areas and acquires a reference position according to the pictures. The microprocessor calculates an offset between the reference position and the unadjusted navigation position and compares the offset with a predetermined offset. The navigation adjusting module adjusts the unadjusted navigation position according to the reference position and the offset comparison and displays a result on the display module.

### BACKGROUND

1. Field of the Invention

Embodiments of the present disclosure generally relate to vehicle navigation, and more particularly to systems and methods for navigating a vehicle.

2. Description of Related Art

Referring to FIG. 5, a global positioning system (GPS) navigation device 100′ is used to navigate a vehicle 99′ to a predetermined destination. Typically, the navigation device 100′ includes a GPS signal processor, a display module, and a memory for storing an electronic map.

The GPS signal processor receives GPS signals transmitted by GPS satellites 200′, and obtains a first navigation position S1′ and a second navigation position S2′ according to the GPS signals. The first navigation position S1′ corresponds to a first actual position S1 of the vehicle 99′, while the second navigation position S2′ corresponds to a second actual position S2 of the vehicle 99′. The vehicle 99 sequentially travels from the first actual position S1 to the second actual position S2, and then to a present actual position S3. The GPS signal processor obtains a present navigation position S3′ according to the following formula: S3′=S2′+(S2′−S1′)/(Δt1*Δt2). In the above mentioned formula, the present navigation position S3′ corresponds to the present actual position S3, a Δt1 denotes a time in which the vehicle 99′ traveled from the first actual position S1 to the second actual position S2, and a Δt2 denotes a time in which the vehicle 99′ traveled from the second actual position S2 to the present actual position S3.

The display module displays the navigation positions S1′, S2′, S3′ on the electronic map. That is, the navigation positions S1′, S2′, S3′ displayed on the electronic map indicate the actual positions S1, S2, S3 of the vehicle.

In the embodiment of FIG. 5, a discrepancy between the navigation positions S1′, S2′, S3′ and the actual positions S1, S2, S3 of the vehicle 99′ is often within an acceptable range. However, when the vehicle 99′ travels in an area when the GPS signal is weak, such as in a tunnel, then the discrepancy between the navigation position and the actual position of the vehicle 99′ is often not within an acceptable range.

Therefore, systems and methods for enhancing vehicle navigation accuracy are needed to address the aforementioned deficiencies and inadequacies.

### SUMMARY

Accordingly, a vehicle navigation system is provided for enhancing navigation accuracy. The vehicle navigation system comprises a GPS signal processor, an image processing module, a memory, a microprocessor, a navigation adjusting module and a display module. The GPS signal processor is used for receiving GPS signals and obtaining an unadjusted navigation position according to the GPS signals. The image processing module is used for capturing a plurality of pictures of an area surrounding a vehicle and acquiring a reference position according to the plurality of pictures. The memory is used for storing a predetermined offset between the reference position and the unadjusted navigation position. The microprocessor is used for calculating an offset between the reference position and the unadjusted navigation position and comparing the offset with the predetermined offset, wherein the microprocessor determines an adjustment signal upon the condition that the offset is larger than or equal to the predetermined offset. The navigation adjusting module is used for adjusting the unadjusted navigation position according the adjustment signal into an adjusted navigation position. The display module is used for displaying the adjusted navigation position on an electronic map. A vehicle navigation method is also disclosed.

Other advantages and novel features of the present disclosure will become more apparent from the following detailed description of preferred embodiment when taken in conjunction with the accompanying drawings, in which:

### BRIEF DESCRIPTION OF THE DRAWINGS

FIG. 1 is a pictorial representation of one embodiment of a vehicle navigation system of the present disclosure;

FIG. 2 is a schematic block diagram of one embodiment of the vehicle navigation system of FIG. 1;

FIG. 3 is a schematic block diagram of one embodiment of an image processing module of FIG. 2;

FIG. 4 is a flowchart illustrating one embodiment of a vehicle navigation method of the present disclosure; and

FIG. 5 is schematic diagram of one embodiment of a conventional vehicle navigation system.

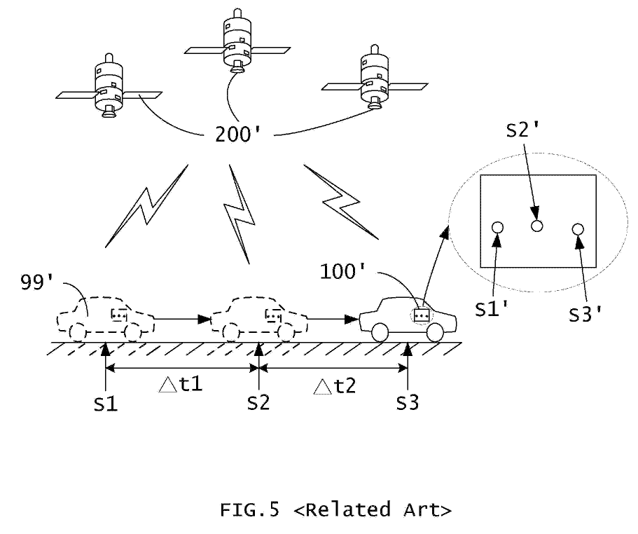

### DETAILED DESCRIPTION OF CERTAIN INVENTIVE EMBODIMENTS

Reference will now be made to the drawings to describe certain inventive embodiments of the present disclosure.

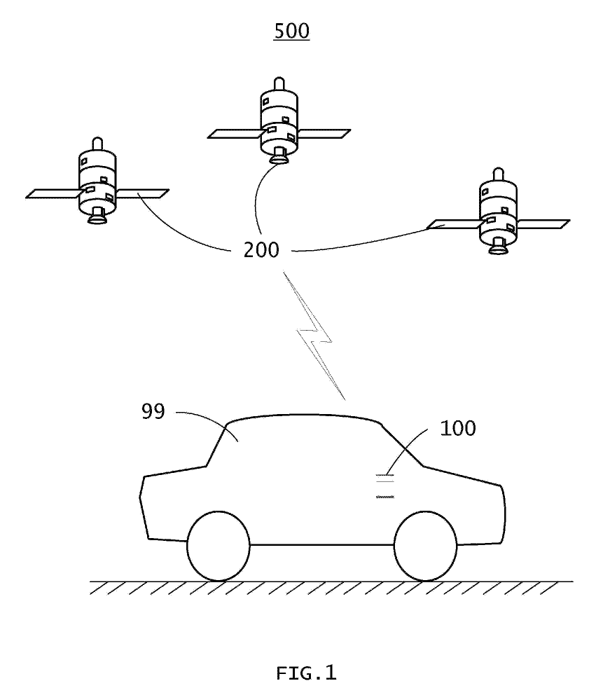

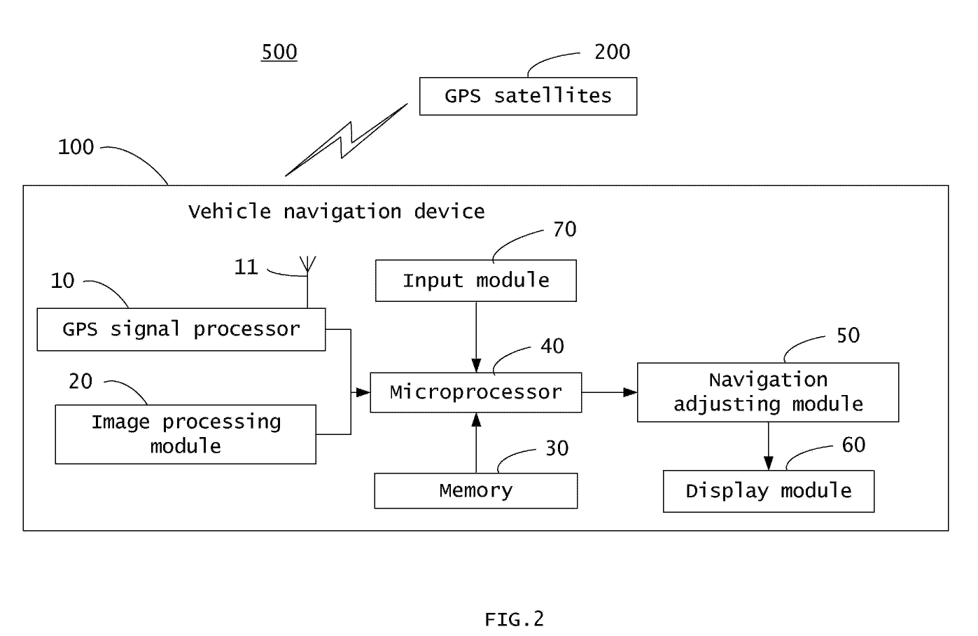

Referring to FIGS. 1 and 2, a vehicle navigation system 500 in accordance with one embodiment of the present disclosure includes a navigation device 100 disposed in a vehicle 99, and GPS satellites 200 for transmitting GPS signals to the navigation device 100.

The navigation device 100 includes a GPS signal processor 10, an image processing module 20, a memory 30, a microprocessor 40, a navigation adjusting module 50, a display module 60, and an input module 70.

The GPS signal processor 10 receives the GPS signals transmitted by the GPS satellites 200 via an antenna 11, and obtains an unadjusted navigation position Sₙ₊₁(Xₙ₊₁, Yₙ₊₁, Zₙ₊₁) of the vehicle 99 according to the GPS signals. It may be understood that a subscript “n” of the equation Sₙ₊₁(Xₙ₊₁,Yₙ₊₁, Zₙ₊₁) represents a natural number, such as, n=0, 1, 2, . . . , for example. The equation Sₙ₊₁(Xₙ₊₁, Yₙ₊₁,Zₙ₊₁) is the unadjusted navigation position when the time is “n+1”, a “Sₙ₊₁” of the equation Sₙ₊₁(Xₙ₊₁,Yₙ₊₁, Zₙ₊₁) represents a point of a predetermined three-dimensional coordinate system, a “(Xₙ₊₁, Yₙ₊₁, Zₙ₊₁)” of the equation Sₙ₊₁(Xₙ₊₁,Yₙ₊₁, Zₙ₊₁) represents a three-dimensional coordinate of the point “Sₙ₊₁”, a “Xₙ₊₁” of the equation Sₙ₊₁(Xₙ₊₁,Yₙ₊₁, Zₙ₊₁) represents a X-axis coordinate of the point “Sₙ₊₁”, a “Yₙ₊₁” of the equation Sₙ₊₁(Xₙ₊₁,Yₙ₊₁, Zₙ₊₁) represents a Y-axis coordinate of the point “Sₙ₊₁”, and a “Zₙ₊₁” of the equation Sₙ₊₁(Xₙ₊₁,Yₙ₊₁, Zₙ₊₁) represents a Z-axis coordinate of the point “Sₙ₊₁”.

The image processing module 20 captures a plurality of pictures, such as pictures P₀, P₁, P₂ . . . Pₙ, Pₙ₊₁ of surrounding areas surrounding the vehicle 99. The image processing module further acquires a reference position S′ₙ₊₁(X′ₙ₊₁,Y′ₙ₊₁,Z′ₙ₊₁) of the vehicle 99 according to the pictures P₀, P₁, P₂ . . . Pₙ, Pₙ₊₁. It may be understood that the plurality of pictures P₀, P₁, P₂ . . . Pₙ, Pₙ₊₁ may be in sequential order and may be sequentially captured at a constant time period between each picture. The equation S′ₙ₊₁(X′ₙ₊₁,Y′ₙ₊₁,Z′ₙ₊₁) is the reference position when the time is “ₙ₊₁”, “Sₙ₊₁” of the equation S′ₙ₊₁(X′ₙ₊₁,Y′ₙ₊₁,Z′ₙ₊₁) represents a point of the predetermined three-dimensional coordinate system, a (X′ₙ₊₁,Y′ₙ₊₁,Z′ₙ₊₁) of the equation S′ₙ₊₁(X′ₙ₊₁,Y′ₙ₊₁,Z′ₙ₊₁) represents a three-dimensional coordinate of the point “S′ₙ₊₁”, a “X′ₙ₊₁” of the equation S′ₙ₊₁(X′ₙ₊₁,Y′ₙ₊₁,Z′ₙ₊₁) represents a X-axis coordinate of the point “Sₙ₊₁”, a “Y′ₙ₊₁” of the equation S′ₙ₊₁(X′ₙ₊₁,Y′ₙ₊₁,Z′ₙ₊₁) represents a Y-axis coordinate of the point “S′ₙ₊₁”, and a “Z′ₙ₊₁” of the equation S′ₙ₊₁(X′ₙ₊₁,Y′ₙ₊₁,Z′ₙ₊₁) represents a Z-axis coordinate of the point “Sₙ₊₁”.

The memory 30 stores an electronic map, a predetermined destination of the vehicle 99, the unadjusted navigation position Sₙ₊₁(Xₙ₊₁,Yₙ₊₁, Zₙ₊₁), the reference position S′ₙ₊₁(X′ₙ₊₁,Y′ₙ₊₁,Z′ₙ₊₁), a predetermined offset ΔR(ΔX, ΔY, ΔZ) between the unadjusted navigation position Sₙ₊₁(Xₙ₊₁,Yₙ₊₁, Zₙ₊₁) and the reference position S′ₙ₊₁ (X′ₙ₊₁,Y′ₙ₊₁,Z′ₙ₊₁), and other GPS related information.

The microprocessor 40 calculates an offset ΔSₙ₊₁((X′ₙ₊₁−Xₙ₊₁), (Y′ₙ₊₁−Yₙ₊₁),(Z′ₙ₊₁−Zₙ₊₁)) between the reference position S′ₙ₊₁ (X′ₙ₊₁,Y′ₙ₊₁,Z′ₙ₊₁) and the unadjusted navigation position Sₙ₊₁(Xₙ₊₁,Yₙ₊₁, Zₙ₊₁). The microprocessor 40 compares the offset ΔSₙ₊₁ ((X′ₙ₊₁−Xₙ₊₁),(Y′ₙ₊₁−Yₙ₊₁),(Z′ₙ₊₁−Zₙ₊₁)) with the predetermined offset Δ R(ΔX, ΔY, ΔZ). In one example, when the offset ΔSₙ₊₁((X′ₙ₊₁−Xₙ₊₁),(Y′ₙ₊₁−Yₙ₊₁),(Z′ₙ₊₁−Zₙ₊₁)) is larger than or equal to the predetermined offset ΔR(ΔX, ΔY, ΔZ), the microprocessor 40 sends an adjustment signal to the navigation adjusting module 50.

The navigation adjusting module 50 adjusts the unadjusted navigation position Sₙ₊₁(Xₙ₊₁,Yₙ₊₁, Zₙ₊₁) of the vehicle 99 according to the reference position S′ₙ₊₁(X′ₙ₊₁,Y′ₙ₊₁,Z′ₙ₊₁) corresponding to the adjustment signal. That is, the adjusted navigation position may be substantially identical with the reference position S′ₙ₊₁(X′ₙ₊₁,Y′ₙ₊₁,Z′ₙ₊₁).

The display module 60 displays the adjusted navigation position S′ₙ₊₁(X′ₙ₊₁,Y′ₙ₊₁,Z′ₙ₊₁) on the electronic map. Thus, the vehicle 99 may be driven to a predetermined destination according to the adjusted navigation position Sₙ₊₁(X′ₙ₊₁,Y′ₙ₊₁,Z′ₙ₊₁). Accordingly, because the adjusted navigation position is substantially identical with the reference position S′ₙ₊₁(X′ₙ₊₁,Y′ₙ₊₁,Z′ₙ₊₁), navigation accuracy of the vehicle 99 is enhanced.

In one embodiment, electronic signals may be inputted to the input module 70 to designate a predetermined destination for the vehicle 99. The input module 70 sends the electronic signals to the microprocessor 40, where the microprocessor 40 computes a route starting from a first position of the vehicle 99 and leading to the predetermined destination. The microprocessor 40 may control the display module 60 to display the route on the electronic map to one or more users. In one embodiment, a predetermined destination may be inputted to the input module 70 using a keyboard, a stylus, a touchscreen, or by voice commands, for example.

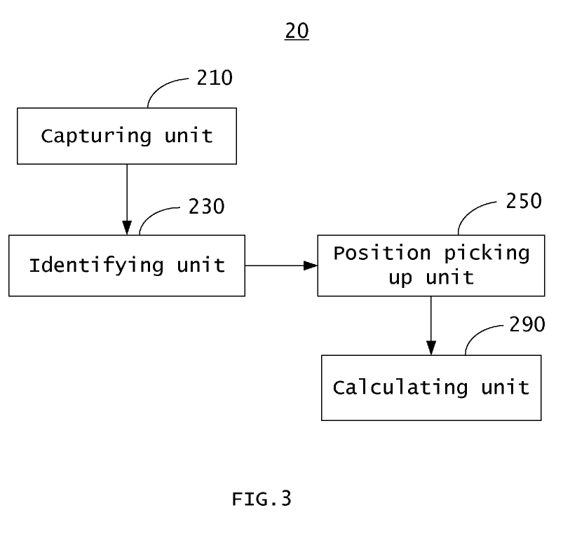

Referring to FIG. 3, the image processing module 20 includes a capturing unit 210, an identifying unit 230, a position picking up unit 250, and a calculating unit 290. The capturing unit 210 captures the consecutive pictures P₀, P₁, P₂ . . . Pₙ, Pₙ₊₁ of a surrounding area around the vehicle 99. The identifying unit 230 identifies a same object (e.g., an identical building, or an identical tree) between the two pictures Pₙ and Pₙ₊₁ according to same data of the two pictures Pₙ and Pₙ₊₁. The position picking up unit 250 determines a change in position ΔS′ₙ₊₁ (ΔX′ₙ₊₁, ΔY′ₙ₊₁, ΔZ′ₙ₊₁) of the same object in the two pictures Pₙ and Pₙ₊₁. The calculating unit 290 calculates the reference position S′ₙ₊₁ (X′ₙ₊₁, Y′ₙ₊₁, Z′ₙ₊₁) of the vehicle 99 according to the change in position ΔS′ₙ₊₁ (ΔX′ₙ₊₁, ΔY′ₙ₊₁, ΔZ′ₙ₊₁) and the reference position Sₙ′(Xₙ′, Yₙ′, Zₙ′). The reference position S′₀(X′₀,Y′₀,Z′₀) is the reference position when the time is “0”. The reference position S′₀(X′₀,Y′₀,Z′₀) can be acquired by many methods, such as by GPS. It may be understood that the consecutive pictures P₀, P₁, P₂ . . . Pₙ, Pₙ₊₁ of a surrounding area around the vehicle 99 may comprise substantially the same data in a given time period. The same data may include one or more objects that are in a consecutive picture capture.

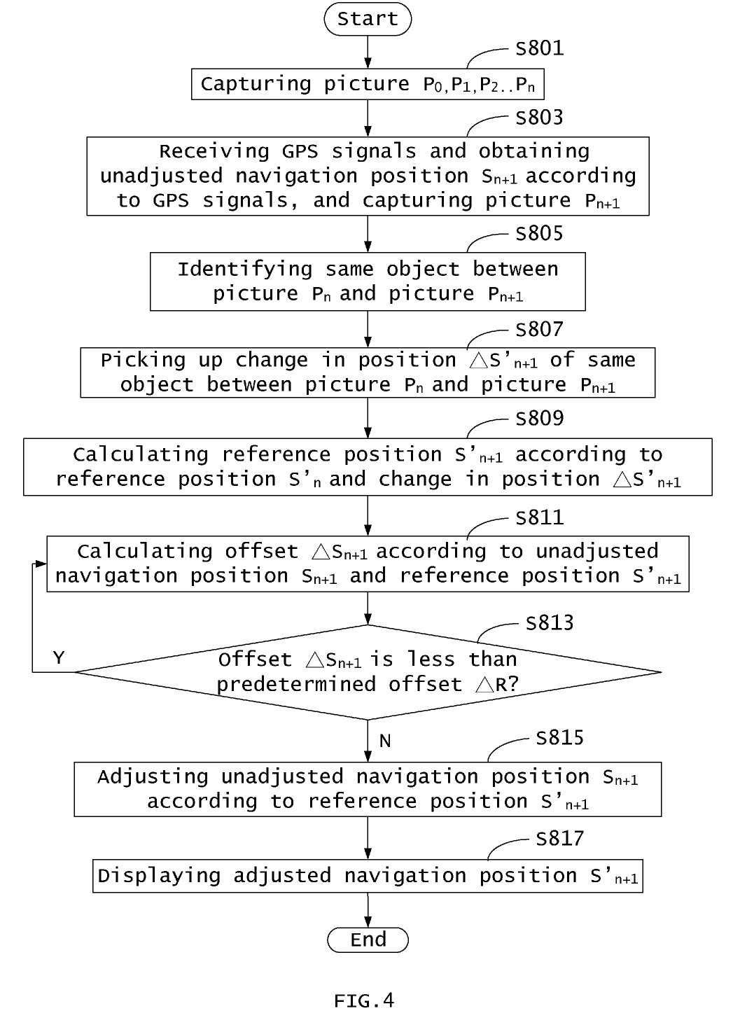

FIG. 4 is a flowchart illustrating one embodiment of a vehicle navigation method of the present disclosure. Depending on the embodiment, the flowchart of FIG. 4 may comprise fewer or additional blocks, and the blocks may be performed in a different order than illustrated.

Beginning in block S801, the image processing module 20 captures the consecutive pictures P₀, P₁, P₂ . . . Pₙ of an area surrounding the vehicle 99.

Moving to block S803, the GPS signal processor 10 receives GPS signals transmitted by the GPS satellites 200 and obtains an unadjusted navigation position Sₙ₊₁(Xₙ₊₁,Yₙ₊₁, Zₙ₊₁) according to the GPS signals. Furthermore, the image processing module 20 captures a picture Pₙ₊₁ of the area surrounding the vehicle 99.

Continuing to block S805, the identifying unit 230 identifies a same object between the picture Pₙ and the picture Pₙ₊₁ according to same data corresponding to the picture Pₙ and the picture Pₙ₊₁.

In block S807, the position picking up unit 250 determines a change in position ΔS′ₙ₊₁ (ΔX′ₙ₊₁,ΔY′ₙ₊₁,ΔZ′ₙ₊₁) of the same object between the picture Pₙ and the picture Pₙ₊₁.

In block S809, the calculating unit 290 calculates the reference position S′ₙ₊₁(X′ₙ₊₁,Y′ₙ₊₁,Z′ₙ₊₁) according to the reference position S′ₙ(X′ₙ,Y′ₙ,Z′ₙ) and the change in position ΔS′ₙ₊₁ (ΔX′ₙ₊₁, ΔY′ₙ₊₁,ΔZ′ₙ₊₁). The reference position S′₀(X′₀,Y′₀,Z′₀) is the reference position when the time is “0”. As mentioned above, the reference position S′₀(X′₀,Y′₀,Z′₀) can be acquired by many methods, such as GPS.

Moving to block S811, the microprocessor 40 calculates an offset ΔSₙ₊₁((X′ₙ₊₁−Xₙ₊₁),(Y′ₙ₊₁−Yₙ₊₁),(Z′ₙ₊₁−Zₙ₊₁)) according to the unadjusted navigation position Sₙ₊₁(Xₙ₊₁,Yₙ₊₁, Zₙ₊₁) and the reference position S′ₙ₊₁ (X′ₙ₊₁,Y′ₙ₊₁,Z′ₙ₊₁).

Continuing to determining block S813, the microprocessor 40 compares the offset ΔSₙ₊₁((X′ₙ₊₁−Xₙ₊₁),(Y′ₙ₊₁−Yₙ₊₁),(Z′ₙ₊₁−Zₙ₊₁)) with a predetermined offset ΔR(ΔX, ΔY, ΔZ). If the offset ΔSₙ₊₁((X′ₙ₊₁−Xₙ₊₁),(Y′ₙ₊₁−Yₙ₊₁) (Z′ₙ₊₁−Zₙ₊₁)) is less than the predetermined offset ΔR(ΔX,ΔY,ΔZ), the procedure goes to block S811. If the offset ΔSₙ₊₁((X′ₙ₊₁−Xₙ₊₁),(Y′ₙ₊₁−Yₙ₊₁),(Z′ₙ₊₁−Zₙ₊₁)) is larger than or equal to the predetermined offset ΔR(ΔX,ΔY,ΔZ), the procedure goes to block S815.

In block S815, the navigation adjusting module 50 adjusts the unadjusted navigation position Sₙ₊₁(Xₙ₊₁,Yₙ₊₁, Zₙ₊₁) according to the reference position S′ₙ₊₁(X′ₙ₊₁,Y′ₙ₊₁,Z′ₙ₊₁). Consequently, an adjusted navigation position may be substantially identical with the reference position S′ₙ₊₁ (X′ₙ₊₁,Y′ₙ₊₁,Z′ₙ₊₁).

In block S817, the display module displays the adjusted navigation position S′ₙ₊₁(X′ₙ₊₁,Y′ₙ₊₁,Z′ₙ₊₁) on the electronic map. Accordingly, the driver may drive the vehicle 99 to a predetermined destination according to the adjusted navigation position.

It is to be understood, however, that even though numerous information and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A vehicle navigation system comprising:
a GPS signal processor for receiving GPS signals, and for obtaining an unadjusted navigation position according to the GPS signals;
an image processing module for capturing a plurality of pictures of an area surrounding a vehicle, and for acquiring a reference position according to the plurality of pictures;
a memory for storing a predetermined offset between the reference position and the unadjusted navigation position;
a microprocessor for calculating an offset between the reference position and the unadjusted navigation position, and for comparing the offset with the predetermined offset, wherein the microprocessor determines an adjustment signal upon the condition that the offset is larger than or equal to the predetermined offset;
a navigation adjusting module for adjusting the unadjusted navigation position according the adjustment signal into an adjusted navigation position; and
a display module for displaying the adjusted navigation position on an electronic map.

2. The vehicle navigation system according to claim 1, wherein the image processing module further comprises:
a capturing unit for capturing the plurality of pictures of the area surrounding the vehicle;
an identifying unit for identifying a same object in two consecutive pictures from the plurality of pictures according to a same data corresponding to the two consecutive pictures from the plurality of pictures;
a position picking up unit for determining a change in position of the same object in the two consecutive pictures; and
a calculating unit for calculating the reference position according to the change in position and a previous reference position.

3. The vehicle navigation system according to claim 1, further comprising:
an input module for responding to input operations, wherein the input operations correspond to a predetermined location for the vehicle, and wherein the microprocessor receives the input operations in order to determine a route to the predetermined location for the vehicle.

4. A vehicle navigation method comprising:
(a) capturing a first picture in a first time period;
(b) receiving a GPS signal and obtaining an unadjusted navigation position according to the GPS signal, and capturing a second picture, wherein the second picture is captured at a second time period, wherein the second time period is after the first time period;
(c) calculating a reference position according to the first picture and the second picture;
(d) calculating an offset between the reference position and the unadjusted navigation position;
(e) comparing the offset with a predetermined offset;
(f) adjusting the unadjusted navigation position according to the reference position upon the condition that the offset is larger than or equal to the predetermined offset; and
(h) displaying the adjusted navigation position.

5. The vehicle navigation method according to claim 4, further comprising:
repeating (d)-(e) upon the condition that the offset is less than the predetermined offset.

6. The vehicle navigation method according to claim 4, wherein the calculating a reference position according to the first picture and the second picture comprises:
identifying a same object between the first picture and the second picture;
determining a change in position of the same object in the first picture and the second picture; and
calculating the reference position according to a change in position between a previous reference position and a next reference position.
